(19) United States
(12) Patent Application Publication
(10) Pub. No.: US 2020/0237004 A1
(43) Pub. Date: Jul. 30, 2020

(54) ELECTRONIC SMOKING SYSTEM

(71) Applicant: Odin & Thor ApS, Karlslunde (DK)

(72) Inventor: Casper Sejer LARSEN, Kiel (DE)

(73) Assignee: Odin & Thor ApS, Karlslunde (DK)

(21) Appl. No.: 16/633,939

(22) PCT Filed: Jun. 21, 2018
(86) PCT No.: PCT/DK2018/050152

§ 371 Date: Jan. 24, 2020

(30) Foreign Application Priority Data
Jul. 27, 2017 (DK) PA201770591
Dec. 19, 2017 (DK) PA201770957

(51) Int. Cl. A24F 40/51; A24F 40/42; A24F 40/10; A24F 40/53; A24F 40/65; A24F 40/20; A24F 40/57; H02J 7/00

(52) U.S. Cl. CPC A24F 40/51; A24F 40/42; A24F 40/10; H02J 7/0063; A24F 40/65; A24F 40/20; A24F 40/57; A24F 40/53

(57) ABSTRACT

An electronic smoking system including an electronic cigarette having an outer shell with an orifice, wherein the outer shell includes a liquid cartridge holding a fluid to be vaporized into a vaporized mixture of air and vaporized fluid, an atomizer for vaporizing the fluid, and a sensor system with one or more sensors configured for detecting a force or pressure exerted by an outer wall surface of the liquid cartridge on the sensor(s). The detected force or pressure may be used as a measure for the fluid volume of the liquid cartridge.

### TECHNICAL FIELD

The disclosure relates to an electronic smoking system, such as an electronic cigarette or a so-called “heat-not-burn” electronic cigarette system, and particularly to an electronic smoking system having a liquid cartridge holding a deliverable-containing fluid to be vaporized and inhaled by a user.

### BACKGROUND

The social benefits of smoking without certain of the downsides may be achieved with a personal inhalation device, such as an electronic cigarette, e-cigarette. An e-cigarette is a device that emulates tobacco cigarette smoking, by producing smoke replacement that may be similar in its physical sensation, general appearance, and sometimes flavor (i.e., with tobacco fragrance, menthol taste, added nicotine etc.). The device may use heat to atomize/vaporize a liquid (for example based on propylene glycol, or glycerin, for example including taste and fragrance ingredients) solution into an aerosol mist. The generated mist may be sensed similar to cigarette smoke. Because it is electronic, an e-cigarette may provide opportunities for increased options, communication, and control.

For portability, and to simulate the physical characteristics of a cigarette, a personal inhalation device or e-cigarette may be battery powered. U.S. Pat. No. 8,851,068 discloses a battery powered personal inhalation device, which includes an outer shell having an orifice formed therein and containing a medium having one or more deliverables and an atomizing unit disposed within the shell. The atomizing unit atomizes the medium when a user puffs on the orifice such that vapor containing the deliverables is discharged through the orifice. The personal inhalation device is further capable of metering the deliverables discharged with the vapor.

US 2013340775 discloses a battery powered e-cigarette, which includes a controller for providing various operations within the e-cigarette. The controller provides operations and control for the e-cigarette with a consumer device, such as a smartphone. Applications on the smartphone may be developed for improving the operations and the control of the e-cigarette, as well as making use of data communicated from the e-cigarette. Applications may be developed for controlling smoke properties, monitoring operations, adjusting settings, receiving product notifications, or compiling/analyzing data from the e-cigarette. Applications may also provide other capabilities that may not be unique to an e-cigarette.

The electronic cigarettes disclosed in U.S. Pat. No. 8,851,068 and US 20139240775 both holds a pressure or airflow sensor, which reacts to a pressure increase due to air flowing through the housing of the electronic cigarette caused by a user taking a puff for starting a smoking session. When activated by the increased air flow, the pressure sensor then activates control electronics and a heating system being part an atomizing unit, which heats and vaporizes the liquid being consumed during a smoking session.

However, when first activating the heating system when the user takes a puff, there is a delay in obtaining the needed temperature for vaporizing the liquid, meaning that the user has to take a longer puff in order to obtain a full smoking experience.

A general problem for battery powered personal inhalation devices is the duration of use time before re-charging of the battery, which is an even bigger problem for personal inhalation devices including wireless communication circuitry for communicating data with an external consumer device, such as a smartphone.

Thus, there is a need for personal inhalation device or e-cigarette having an electronic control system for providing an improved heating of liquid to be vaporized, and for providing an improved control of battery power consumption during a user's smoking session.

Another general problem for personal inhalation devices is to keep track of the remaining deliverable-containing fluid, which is to be vaporized and inhaled.

WO 2017/045897 A1 discloses a cartridge for an aerosol-generating system for use in an e-cigarette, which cartridge holds a capacitor sensor with two capacitor plates for sensing the amount of liquid or fluid within the cartridge. However, the disclosed liquid cartridge with capacitor plates may not be a convenient design for refilling of the cartridge.

Thus, there is a need for a personal inhalation device or e-cigarette having an improved sensor system for detecting the fluid level of a liquid cartridge holding a deliverable-containing fluid, which is to be vaporized and inhaled, and which sensor system allows an easy refill of the cartridge.

### SUMMARY

The aspects of the disclosed embodiments are directed to providing an improved method and system for controlling power consumption of a personal inhalation device when being in use.

In accordance with a first aspect provided is a method of controlling power consumption during a smoking session performed by use of an electronic smoking system comprising an activation contact, a heating system for heating a fluid to be vaporized or for heating a tobacco plug and including a temperature sensor for sensing the temperature of the heating system, a short range wireless communication module configured for wireless data communication with an external computer or smartphone, control circuitry in electronically communication with the activation contact and the heating system and the short range wireless communication module, and a battery for powering the heating system and the short range wireless communication module and the control circuitry, said method comprising:

shifting the operation mode of the control circuitry from a powered non-active mode or sleep mode into an active mode by having a user maintaining the activation contact in a first, active smoking position for at least a predetermined minimum puff time period to thereby start a smoking session;

supplying battery power to the heating system when the operation mode of the control circuitry is shifted into said active mode;

determining the temperature of the activated heating system; and

de-activating the battery power supply to the heating system when the heating system temperature reaches a predetermined maximum temperature or when the activation contact is turned from the first, active smoking position into a second, non-active position.

For the method and system of the present disclosure, the user starts a smoking process by use of the activation contact, which the user holds in a smoking position during the smoking process. The user may then start taking a puff after the activation contact is brought into the smoking position. For the method and system of the present disclosure, the control circuitry and the heating system is activated just after the activation contact is brought into the smoking position. The heating of the fluid to be vaporized during a puff will then in most cases start before the user takes a puff, and thereby enhancing the smoking experience.

One of the main power consuming components of an electronic smoking system is the heating system, and by monitoring the temperature of the heating system, excess heating of the fluid is avoided, and excess use of battery power is avoided.

In a possible implementation form of the method of the first aspect, the method further comprises:

shifting the operation mode of the short range wireless communication module from a powered non-active mode or sleep mode into an active data communication mode when the control circuitry is turned into said active mode;

determining after lapse of a predetermined communication time period starting from turning the short range wireless communication module into said active data communication mode, whether the short range wireless communication module is in a data communication session with an external computer or smartphone; if not, then

shifting the operation mode of the short range wireless communication module into the powered non-active mode or sleep mode; and if yes, then

shifting the operation mode of the short range wireless communication module into the powered non-active mode or sleep mode when the data communication session is ended.

The wireless communication circuitry for communicating data with an external consumer device is another main power consuming component of an electronic smoking system. Usually, the wireless communication circuitry is maintained in an active data communication mode, when the electronic smoking system is active during a smoking session. By using a predetermined period for data communication, excess use of battery power is avoided.

In a possible implementation form of the method of the first aspect, the method further comprises:

ending the smoking session by having the user turning or switching the activation contact from the first, active smoking position into the second, non-active position, thereby shifting the operation mode of the control circuitry from the powered active mode into the powered non-active mode or sleep mode.

In a possible implementation form of the method of the first aspect, then upon said turning or switching of the activation contact from the first, active smoking position into the second, non-active position, the operation mode of the control circuitry is only shifted from the powered active mode into the powered non-active mode or sleep mode when the operation mode of the short range wireless communication module has been shifted into the powered non-active mode or sleep mode.

In a possible implementation form of the method of the first aspect, then before a smoking session is started, the operation mode of the electronic smoking system is shifted from a non-powered off mode to a powered mode in which the electronic smoking system is in a non-active or sleep mode, said operation mode being shifted by several consecutive user activations of the activation contact, whereby the operation mode of the control circuitry is shifted from a non-powered mode to the powered non-active sleep mode and the operation mode of the short range wireless communication module is shifted from a non-powered mode to the powered non-active mode or sleep mode.

In a possible implementation form of the method of the first aspect, then after a smoking session is ended, the operation mode of the electronic smoking system is shifted from the powered non-active or sleep mode to the non-powered off mode by several consecutive user activations of the activation contact, whereby the operation mode of the control circuitry is shifted from the powered non-active sleep mode to a non-powered mode and the operation mode of the short range wireless communication module is shifted from the powered non-active mode or sleep mode to the non-powered mode.

In a possible implementation form of the method of the first aspect, the temperature sensor is a power consuming sensor, and the method comprises supplying battery power to the temperature sensor when supplying battery power to the heating system, determining the temperature of the activated heating system, and de-activating the battery power supply to the temperature sensor when de-activating the battery power supply to the heating system.

In a possible implementation form of the method of the first aspect, the control circuitry is configured for determining remaining battery charge, and the data representing the determined remaining battery charge is communicated by the control circuitry to the short range wireless communication module and further communicated by the short range wireless communication module to the external computer or smartphone when both the control circuitry and the short range wireless communication module are in the active mode.

In a possible implementation form of the method of the first aspect, the electronic smoking system comprises an electronic cigarette having an outer shell with an orifice, said outer shell holding a liquid cartridge with a fluid to be vaporized into a vaporized mixture of air and vaporized fluid, and said outer shell further holding an atomizer for vaporizing the fluid, wherein the heating system is part of the atomizer and the atomizer is arranged for vaporizing the fluid into said mixture when a user puffs on the orifice and heat is delivered from the heating system, and wherein the electronic cigarette holds an airflow sensor for detecting a change in air pressure caused by user puff, and wherein the method further comprises:

activating the airflow sensor when the operation mode of the control circuitry is shifted into said active mode when a user starts a smoking session by maintaining the activation contact in the first, active smoking position for at least a predetermined minimum puff time period;

detecting an increase in airflow during start of a user puff, if any, and storing the detected increase in airflow as a detected user puff, and de-activating the airflow sensor when the activation contact is turned from the first, active smoking position into a second, non-active position.

In a possible implementation form of the method of the first aspect, the electronic cigarette holds a liquid volume sensor for sensing the volume of fluid in the liquid cartridge, and the method further comprises:

activating the liquid volume sensor when the operation mode of the control circuitry is shifted into said active mode when a user starts a smoking session by maintaining the activation contact in the first, active smoking position for at least a predetermined minimum puff time period;

detecting volume of fluid in the liquid cartridge and storing the detected fluid volume; and

de-activating the liquid volume sensor when the detected fluid volume is stored or when the activation contact is turned from the first, active smoking position into a second, non-active position.

In a possible implementation form of the method of the first aspect, data representing the number of detected and stored user puffs and/or data representing the last detected and stored fluid volume is communicated by the control circuitry to the short range wireless communication module, and further communicated by the short range wireless communication module to an external computer or smartphone when both the control circuitry and the short range wireless communication module are in the powered active mode.

According to the first aspect there is also provided an electronic smoking system comprising:

an activation contact;

a heating system for heating a fluid to be vaporized or for heating a tobacco plug and including a temperature sensor for sensing the temperature of the heating system;

a short range wireless communication module configured for wireless data communication with an external computer or smartphone;

control circuitry in electronically communication with the activation contact, the heating system and the short range wireless communication module; and

a battery for powering the heating system, the short range wireless communication module, and the control circuitry;

wherein the control circuitry is configured for:

shifting operation mode from a powered non-active mode or sleep mode into an active mode when the activation contact is maintained in a first, active smoking position for at least a predetermined minimum puff time period;

activating the heating system by directing battery power supply to the heating system when the activation contact is maintained in said first, active smoking position;

determining the temperature of the activated heating system; and

de-activating the battery power supply to the heating system when the heating system temperature reaches a predetermined maximum temperature or when the activation contact is turned from the first, active smoking position into a second, non-active position.

In a possible implementation form of the system of the first aspect, the control circuitry is further configured for:

shifting the operation mode of the short range wireless communication module from a powered non-active mode or sleep mode into an active data communication mode when the activation contact is maintained in the first, smoking active position;

determining after lapse of a predetermined communication time period starting from the shifting of operation mode of the short range wireless communication module into said active data communication mode, whether the short range wireless communication module is in a data communication session with an external computer or smartphone; if not, then

shifting the operation mode of the short range wireless communication module into the powered non-active mode or sleep mode; and if yes, then

shifting the operation mode of the short range wireless communication module into the powered non-active mode or sleep mode when the data communication session is ended.

In a possible implementation form of the system of the first aspect, the control circuitry is configured for shifting operation mode from the powered active mode into the powered non-active mode or sleep mode when the activation contact is turned or switched from the first, active smoking position into the second, non-active position.

In a possible implementation form of the system of the first aspect, then upon said turning or switching of the activation contact from the first, active smoking position into the second, non-active position, the control circuitry is configured for shifting operation mode from the powered active mode into the powered non-active mode or sleep mode only when the operation mode of the short range wireless communication module has been shifted into the powered non-active mode or sleep mode.

In a possible implementation form of the system of the first aspect, the activation contact and the control circuitry are configured for shifting the operation mode of the control circuitry from a non-powered mode to the powered non-active sleep mode by several consecutive activations of the activation contact.

In a possible implementation form of the system of the first aspect, the control circuitry is configured for shifting the operation mode of the short range wireless communication module from a non-powered mode to the powered non-active mode or sleep mode when the operation mode of the control circuitry is shifted into the powered non-active or sleep mode by said several consecutive activations of the activation contact.

In a possible implementation form of the system of the first aspect, the activation contact and the control circuitry are configured for shifting the operation mode of the control circuitry from the powered active mode or powered non-active sleep mode into the non-powered mode by several consecutive activations of the activation contact.

In a possible implementation form of the system of the first aspect, the control circuitry is configured for shifting the operation mode of the short range wireless communication module from the powered active data communication mode or the powered non-active mode or sleep mode into the non-powered mode when the operation mode of the control circuitry is shifted into the non-powered mode by said several consecutive activations of the activation contact.

In a possible implementation form of the system of the first aspect, the temperature sensor is a power consuming sensor, and the control system is configured for:

activating the temperature sensor by directing battery power to the temperature sensor when activating the heating system, and

de-activating the battery power supply to the temperature sensor when de-activating the battery power supply to the heating system.

In a possible implementation form of the system of the first aspect, the control circuitry is configured for determining remaining battery charge, and the control circuitry is configured for communicating data representing the determined remaining battery charge to the short range wireless communication module, and the short range wireless communication module is configured for communicating the received battery charge data to the external computer or smartphone when both the control circuitry and the short range wireless communication module are in the active mode.

In a possible implementation form of the system of the first aspect, the electronic smoking system comprises an electronic cigarette having an outer shell with an orifice, said outer shell holding a liquid cartridge with a fluid to be vaporized into a vaporized mixture of air and vaporized fluid, and said outer shell further holding an atomizer for vaporizing the fluid, wherein the heating system is part of the atomizer and the atomizer is arranged for vaporizing the fluid into said mixture when a user puffs on the orifice and heat is delivered from the heating system, and wherein the electronic cigarette holds an airflow sensor for detecting a change in air pressure caused by a user puff.

In a possible implementation form of the system of the first aspect, the control circuitry is configured for communicating data representing a number of detected user puffs to the short range wireless communication module, and the short range wireless communication module is configured for communicating the received user puff data to the external computer or smartphone when both the control circuitry and the short range wireless communication module are in the active mode.

In a possible implementation form of the system of the first aspect, the electronic cigarette holds a liquid volume sensor for detecting the volume of fluid in the liquid cartridge.

In a possible implementation form of the system of the first aspect, the control circuitry is configured for communicating data representing the detected fluid volume of the liquid cartridge to the short range wireless communication module, and the short range wireless communication module is configured for communicating the received fluid volume data to the external computer or smartphone when both the control circuitry and the short range wireless communication module are in the active mode.

It is an object of the aspects of the disclosed embodiments to provide an electronic smoking system holding an improved sensor system for detecting the fluid level of a liquid cartridge holding a deliverable-containing fluid, which is to be vaporized and inhaled.

This object is achieved in accordance with a second aspect by providing an electronic smoking system comprising an electronic cigarette having an outer shell with an orifice, said outer shell comprising:

a liquid cartridge holding a fluid to be vaporized into a vaporized mixture of air and vaporized fluid;

an atomizer for vaporizing the fluid; and

a sensor system with one or more sensors configured for detecting a force or pressure exerted by an outer wall surface of the liquid cartridge on the sensor(s), said detected force or pressure relating to the fluid volume of the liquid cartridge.

In a possible implementation form of the system of the second aspect, the outer shell has one or more inner side wall surfaces and an inner bottom wall surface, which inner surfaces at least partly enclose the liquid cartridge, said liquid cartridge being formed by a least one or more side wall parts, a bottom wall part and a top part. In a possible implementation form of the system of the second aspect, at least one sensor is positioned between the inner bottom wall surface of the outer shell and the outer bottom wall surface of the liquid cartridge. In a possible implementation form of the system of the second aspect, at least one sensor is positioned between an inner side wall surface of the outer shell and an outer side wall surface of the liquid cartridge.

In a possible implementation form of the system of the second aspect, the sensor system holds at least two sensors arranged for detecting a force or pressure exerted by one or more outer wall surfaces of the liquid cartridge on said sensors.

In a possible implementation form of the system of the second aspect, at least one sensor is positioned between the inner bottom wall surface of the outer shell and the outer bottom wall surface of the liquid cartridge, and at least one sensor is positioned between an inner side wall surface of the outer shell and an outer side wall surface of the liquid cartridge.

In a possible implementation form of the system of the second aspect, the liquid cartridge comprises one or more flexible parts providing a flexibility to the liquid cartridge relative to the outer shell, thereby allowing the liquid carrier to exert a gravity force or pressure on said sensor(s), said gravity force or pressure being at least partly a function of the fluid volume of the liquid carrier.

The gravity force or pressure may be a function of both the fluid volume and the vertical position of the liquid cartridge relative to the position of the force/pressure sensor(s).

In a possible implementation form of the system of the second aspect, the liquid cartridge comprises one or more flexible wall parts, and the sensor(s) is/are positioned for detecting a gravity force or pressure exerted from an outer surface of said one or more flexible wall parts.

In a possible implementation form of the system of the second aspect, the bottom wall part of the liquid cartridge holds a flexible wall part facing said at least one sensor positioned between the inner bottom wall surface of the outer shell and the outer bottom wall surface of the liquid cartridge. In a possible implementation form of the system of the second aspect, at least one side wall part of the liquid cartridge holds a flexible wall part facing said at least one sensor positioned between an inner side wall surface of the outer shell and an outer side wall surface of the liquid cartridge.

In a possible implementation form of the system of the second aspect, the liquid cartridge has one or more side wall parts, a bottom wall part, a top part attached to the outer shell, and a flexible interconnection part providing a flexible connection between the top part and the side wall parts, and the sensor(s) is/are positioned for detecting a gravity force or pressure exerted from an outer surface of said one or more side and/or bottom wall parts.

The top part may be a rigid top part, also the side wall parts may be of a rigid material. The bottom wall part may also be of a rigid material.

In a possible implementation form of the system of the second aspect, the one or more force or pressure detecting sensors include one or more piezoresistive strain gauge type sensors and/or one or more force sensing resistor type sensors. The one or more force or pressure detecting sensors may include one or more compression load cells, such a micro-machined piezoresistive strain gauge cell.

In a possible implementation form of the system of the second aspect, the liquid cartridge is formed by a least one or more side wall parts, a bottom wall part and a top part, and the side wall parts and the bottom wall part are at least partly made of a plastic material or flexible plastic material.

In a possible implementation form of the system of the second aspect, the top part comprises a threaded part for attachment of the liquid cartridge to the outer shell.

In a possible implementation form of the system of the second aspect, the flexible interconnection part is made of a flexible plastic material.

In a possible implementation form of the system of the second aspect, the electronic cigarette further comprises:

control circuitry in electronically communication with the sensor system, said control circuitry being configured for determining the remaining volume of the fluid within the liquid cartridge based at least partly on received force/pressure data detected by the one or more force/pressure detecting sensors.

In a possible implementation form of the system of the second aspect, the control circuitry is configured for determining the remaining volume of the fluid within the liquid cartridge based at least partly on received force/pressure data detected by at least two force/pressure detecting sensors.

In a possible implementation form of the system of the second aspect, the control circuitry is configured for combining or summing the received force/pressure data detected by the at least two force/pressure detecting sensors, and for determining the remaining volume of the fluid within the liquid cartridge based at least partly on the resulting combined or summed force/pressure data.

In a possible implementation form of the system of the second aspect, the control circuitry is configured for determining a maximum value of the received force/pressure data or for determining a maximum value for the combined or summed force/pressure data, and further configured for determining the remaining volume of the fluid within the liquid cartridge based at least partly on said determined maximum value.

In a possible implementation form of the system of the second aspect, the control circuitry holds stored information representing minimum and maximum gravity force or pressure values, wherein the minimum value represents the force or pressure exerted by a liquid cartridge holding a minimum fluid volume and the maximum value represents the force or pressure exerted by a liquid cartridge holding a maximum fluid volume; and the control circuitry is configured for determining a remaining volume of the fluid within the liquid cartridge based on received force/pressure data detected by the one or more force/pressure detecting sensors and the stored minimum and maximum force/pressure values.

In a possible implementation form of the system of the second aspect, the control circuitry is configured for determining the remaining volume of the fluid within the liquid cartridge based at least partly on the combined or summed force/pressure data and the stored minimum and maximum force/pressure values.

In a possible implementation form of the system of the second aspect, the control circuitry is configured for determining the remaining volume of the fluid within the liquid cartridge based on said determined maximum value and the stored minimum and maximum force/pressure values.

In a possible implementation form of the system of the second aspect, the electronic cigarette further comprises a short range wireless communication module in electronically communication with the control circuitry and configured for wireless data communication of a determined remaining fluid volume to an external computer or smartphone.

In a possible implementation form of the system of the second aspect, the electronic cigarette further comprises a heating system for heating the fluid to be vaporized, which heating system includes a temperature sensor for sensing the temperature of the heating system, wherein the heating system is part of the atomizer and the atomizer is arranged for vaporizing the fluid into said mixture when a user puffs on the orifice and heat is delivered from the heating system. In a possible implementation form of the system of the second aspect, the electronic cigarette further comprises a power delivering battery.

In a possible implementation form of the system of the second aspect, the electronic cigarette further comprises an airflow sensor for detecting a change in air pressure caused by a user puff; wherein the control circuitry and the airflow sensor are configured for detecting a lowering in air pressure; and wherein the control circuitry is configured for determining the remaining volume of the fluid within the liquid cartridge following a detection of a lowering in air pressure.

In order to provide a fluid volume sensing system for an electronic cigarette, it is important for to have a fluid containing liquid cartridge, which can interact with one or more sensors arranged for providing a measure being a function of the volume of the fluid within the container. When using force or pressure sensors, this is achieved in accordance with a third aspect by providing a liquid cartridge for holding a consumption fluid for an electronic cigarette, said liquid cartridge comprising one or more side wall parts, a bottom wall part, a rigid top part, and a flexible interconnection part providing a flexible connection between the top part and the side wall parts.

In a possible implementation form of the liquid cartridge of the third aspect, the top part comprises a threaded part for attachment of the liquid cartridge to an outer shell of an electronic cigarette.

In a possible implementation form of the liquid cartridge of the third aspect, the flexible interconnection part is made of a flexible plastic material.

In a possible implementation form of the liquid cartridge of the third aspect, the one or more side wall parts and the bottom wall part are at least partly made of a non-flexible or rigid plastic material.

The foregoing and other objects are achieved by the features of the independent claims. Further implementation forms are apparent from the dependent claims, the description and the figures. These and other aspects of the present disclosure will be apparent from the embodiments described below.

### BRIEF DESCRIPTION OF THE DRAWINGS

In the following detailed portion of the present disclosure, the aspects of the disclosed embodiments will be explained in more detail with reference to the example embodiments shown in the drawings, in which:

FIGS. 1a and 1b are an exploded view and a bottom view, respectively, of an electronic cigarette according to an example embodiment;

FIG. 2 is a block diagram illustrating local communication between an electronic cigarette and a smartphone, and network communication via the smartphone according to an example embodiment;

FIG. 3 is a block diagram illustration components of an electronic smoking system according to an example embodiment;

FIG. 4 is a block diagram illustrating a smoking control process according to an example embodiment;

FIG. 5 is a block diagram illustrating details of the smoking control process of FIG. 4 according to an example embodiment;

FIG. 6 is a block diagram illustrating further details of the smoking control process of FIG. 4 according to an example embodiment;

FIG. 7 is a timing diagram for a smoking control process according to an example embodiment;

FIG. 8 is a block diagram illustrating the arrangement of an atomizer according to an example embodiment;

FIG. 9 is a block diagram illustrating heating of a tobacco plug according to an example embodiment;

FIG. 10 shows a liquid cartridge for use in an electronic cigarette according to an example embodiment;

FIG. 11 shows another liquid cartridge for use in an electronic cigarette according to an example embodiment; and

FIG. 12 is a block diagram illustrating the arrangement of an atomizer and a liquid cartridge according to an example embodiment.

### DETAILED DESCRIPTION

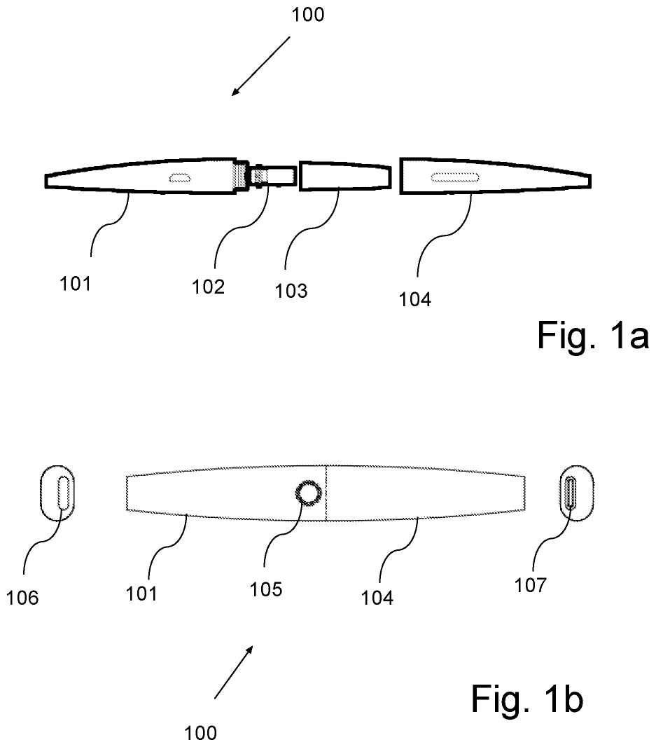

FIGS. 1a and 1b are an exploded view and a bottom view, respectively, of a personal inhalation device or electronic cigarette 100 according to an example embodiment.

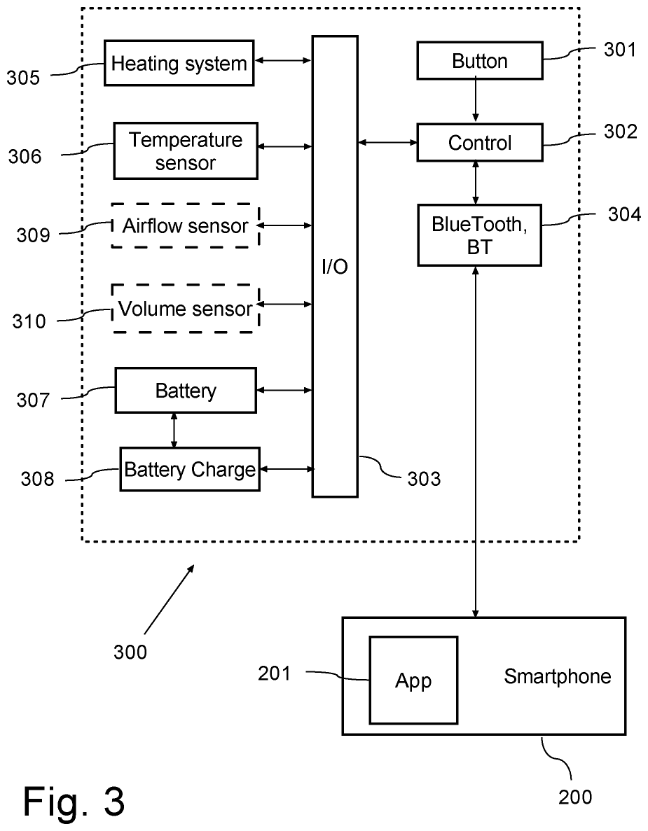

The electronic cigarette 100 has a housing comprising a first outer shell 101 and a second outer shell 104. The electronic cigarette 100 includes: an electronics section with control circuitry, sensors and a battery (see FIG. 3), which may be housed in the first outer shell 101, an atomizing unit 102 and a liquid cartridge 103, which are housed in the second outer shell 104. The atomizing unit 102 may hold a heating system, such as a heating coil, for heating a liquid to be vaporized when a user takes a puff.

The electronics section may be connected to one end of the atomizing unit 102 by means of a screw-on connection, and the liquid cartridge 103 may be connected to the other end of the atomizing unit 102 by an interference fit. When assembled, the electronic cigarette 100 defines an elongated shape having a length-to-diameter ratio that may be close to the length-to-diameter ratio of a standard cigarette as illustrated in FIG. 1b.

The second outer shell 104 of the housing has an outlet hole or orifice 107 at the end (i.e. a mouth end), where a user can place his lips to breathe in vapor or gas generated by the atomizing unit 102. An inlet hole or orifice 106 may be provided at the opposite end of the housing, i.e. at the end of the first outer shell 101 to allow air to enter the housing when a user draws or puffs on the mouth end holding the orifice 107, thereby drawing air through the housing of the electronic cigarette 100.

The liquid cartridge 103 stores a deliverable-containing medium which is atomized in the heated atomizing unit 102, when a user draws or puffs on the mouth, which creates a vapor that is inhaled by the user through the orifice 107. The operation of the electronic cigarette 100 is controlled by the control circuitry contained in the electronics section of the first outer shell 101, and a user activation contact, such as a push button, 105, which may be positioned at the bottom side of the first outer shell 101, close to the second outer shell 104.

The heating system may be connected to or include a temperature sensor for detecting the temperature of the heating system, and an airflow sensor may be provided as part of the electronic section within the first outer shell 101. The airflow sensor may be activated by a pressure drop across the sensor caused by a user taking a puff, thereby creating a a change in air pressure within the first outer shell 101.

It is also within an embodiment that the electronic section holds or is connected to one or more sensors for detecting the volume of fluid in the liquid cartridge 103. In an embodiment the electronic cigarette 100 holds one or more force sensors arranged for detecting a weight change of the liquid cartridge 103, which is caused by the consumption of liquid during a user's smoking session. The remaining liquid within the cartridge 103 can then be calculated based on the output of the force sensor(s).

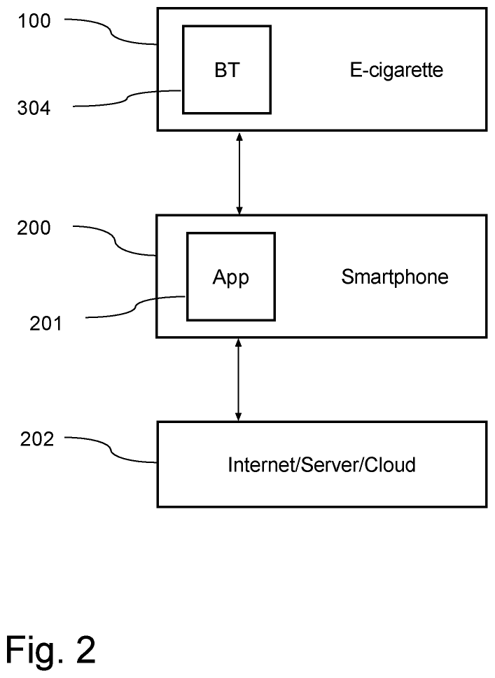

The electronic section may also hold a short range wireless communication module, which may be a BlueTooth module, for wireless data communication with an external computer or external user device, such as a smartphone. This is further illustrated in FIG. 2, which is a block diagram illustrating local communication between an electronic cigarette 100 equipped with a BlueTooth module 304, for wireless communication between the electronic cigarette 100 and a user device, such as a smartphone 200. The smartphone may hold an application program, App, 201, which may be a “Smoke Management Application”, and which may store data received from the electronic cigarette 100. Such data may include numbers of detected user puffs, used or remaining liquid in the liquid cartridge 103, and remaining battery charge. The received data may further be communicated from the smartphone to a server 202 via network communication.

FIG. 3 is a block diagram illustration components of an electronic smoking system 300 according to an example embodiment. The electronic smoking system 300 comprises an activation contact 301, a heating system 305 for heating a fluid to be vaporized or for heating a tobacco plug, a temperature sensor 306 for sensing the temperature of the heating system 305, a short range wireless communication module, such as a BlueTooth module, 304 configured for wireless data communication with an external computer or smartphone 200 holding an application program, App, 201, control circuitry 302 with input-output interface circuitry 303, I/O, a battery 307 and battery charging control circuitry 308. The control circuitry 302 is in electronically communication with the activation contact or button 301, the heating system 305 with the temperature sensor 306, the short range wireless communication module 304, and the battery charging control circuitry 308. The battery 307 delivers power to the heating system 305, the control circuitry 302, and short range wireless communication module 304, and the control circuitry 302 controls the operation modes and thereby the power consumption of the temperature system 305 and the wireless communication module 304.

For the electronic cigarette 100, the heating system 305 may be part of the atomizing unit 102, which together with the fluid or liquid cartridge 103 are positioned within the second outer shell 104, which holds the vapor outlet hole 107. The activation contact 301 may be a push button 105 positioned at the bottom side of the first outer shell 101, and the control circuitry 302 with the interface circuitry 303, the battery 307, the battery charge control circuitry 308, and the wireless communication module 304 may all be positioned within the first outer shell 101. In an embodiment the electronic cigarette 100 may be provided with an airflow or pressure sensor 309, which may be part of the electronic smoking system and positioned within the first outer shell 101. The airflow sensor 309 may be activated by a pressure drop across the sensor caused by a user taking a puff, thereby creating a change in air pressure within the first outer shell 101.

In an embodiment the electronic cigarette 100 may hold a volume sensor 310 for monitoring the remaining fluid or liquid in the liquid cartridge 103. The volume sensor 310 may be one or more force sensors, such as two force sensors arranged for detecting a weight change of the liquid cartridge 103. The remaining liquid within the cartridge 103 can then be calculated based on the weight output of the force sensors 310. The two force sensors 310 may be arranged within the second outer shell 104 such that a first force sensor contacts an outer bottom part of the liquid cartridge 103 and a second force sensor contacts an outer side part of the liquid cartridge 103 when the liquid cartridge is positioned within the second outer shell 104 and secured to the atomizing unit 102. Electric contacts may be provided between the first and second outer shells 101, 104 in order for the control circuitry 302 to be in electronic communication with the force sensors 310.

The two force sensors may measure the weight of the liquid cartridge 103 including the fluid or liquid within the cartridge 103 by gravity. Thus, when the electronic cigarette 100 is held in a vertical position, the first force sensor may be pressurized by the weight of the liquid cartridge 103, and when the electronic cigarette 100 is held in a horizontal position, the second force sensor may be pressurized by the weight of the liquid cartridge 103.

As illustrated by the dashed lines of the airflow sensor 309 and the volume sensor 310 in FIG. 3, both of these sensors are optional for the electronic smoking system 300 of the present disclosure.

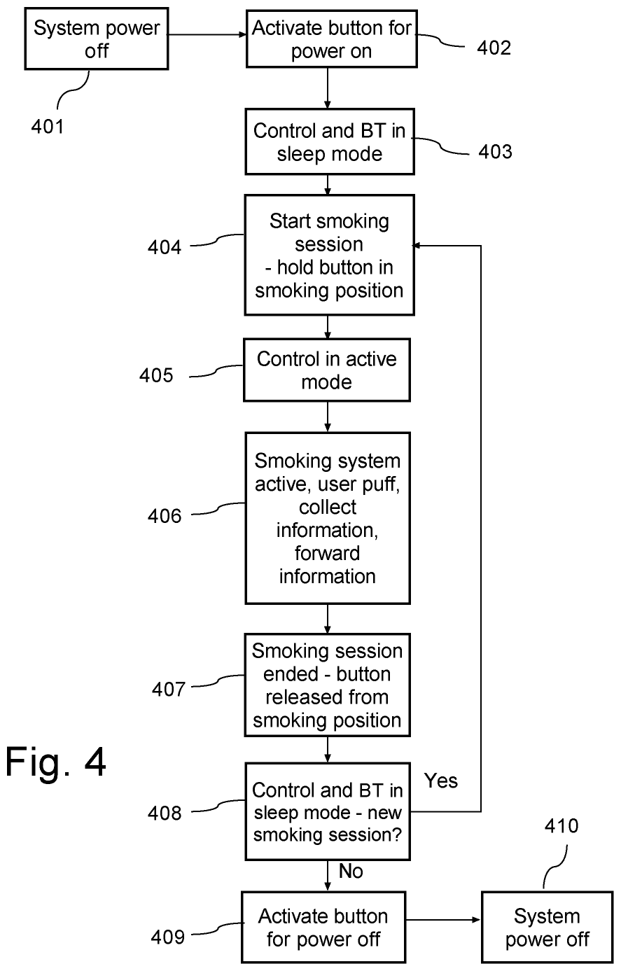

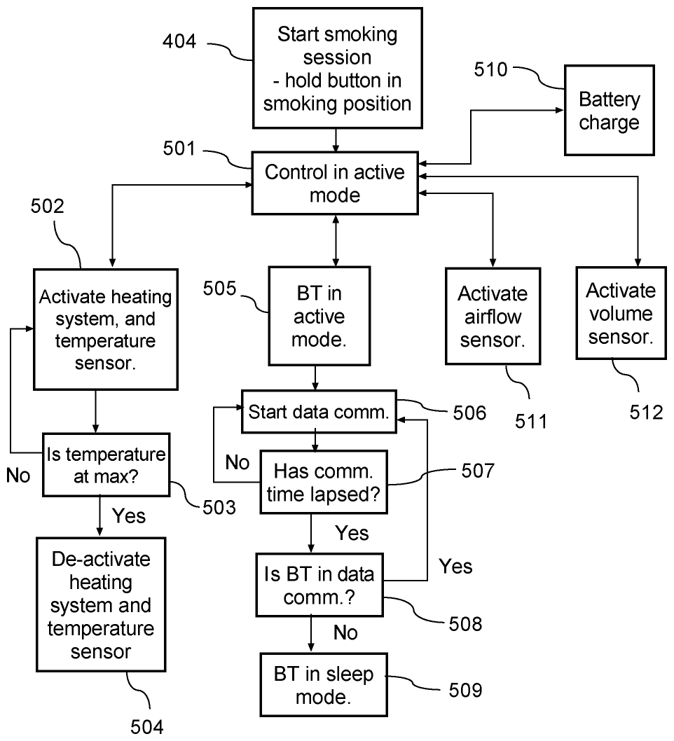

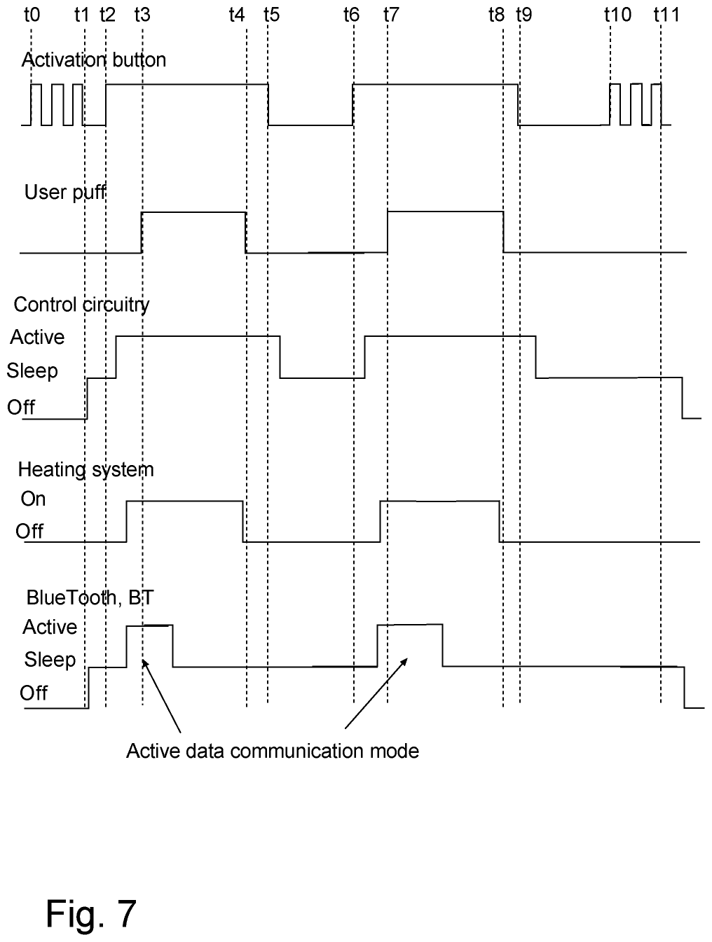

The operation of the electronic smoking system 300 when controlling the electronic power consumption during a smoking process will now be described in further details in connection with the block diagrams of FIGS. 4, 5 and 6, and the timing diagram of FIG. 7.

A smoking control process from system power on to system power off is illustrated in FIG. 4, and the timing of the process is illustrated in FIG. 7. Before time t0, the system 300 is in power off, step 401, with no battery power being used by the electronic components of the system 300. From time t0 to t1, the user presses the activation contact or button 105, 301 several times, such as three times, quickly in a row in order to power on the system 300, step 402. At time t1, the control circuitry 302 is powered on and changes mode from a non-powered off mode to a powered mode in which the control circuitry 302 is in a non-active or sleep mode, step 403. At step 403, the change of mode of the control circuitry 302 also changes the operation mode of the short range wireless communication module 304 from a non-powered mode to a powered non-active mode or sleep mode.

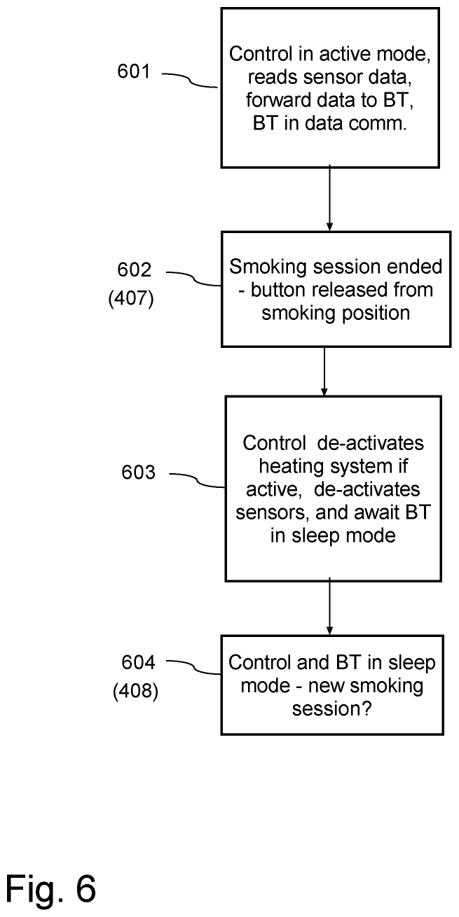

At time t2, the user starts a smoking process by pressing the activation contact or button 105, 301 into an active smoking position and keeping the button 105, 301 in this position, step 404. When the button 105, 301 has been maintained in the smoking position for a minimum period, which is longer than one of the press periods used for powering the system in step 402, the operation mode of the control circuitry shifts from the powered non-active mode or sleep mode into an active mode, steps 404 and 405. When in the active mode of step 405, the electronic smoking system is fully active, and the control circuitry 302 proceeds and monitors the heating system 305, the wireless communication or BlueTooth module 304, collects sensor data, and forward sensor data to the wireless communication or BlueTooth module 304, step 406. The operations performed at step 406 are further described in connection with FIGS. 5 and 6.

After the user has activated the system 300 for a smoking session at time t2, the user usually will take a smoking puff at time t3, which puff ends at time t4. A puff period from time t3 to time t4 may be about 3-4 seconds. After finishing his puff at time t5, the user releases the activation contact or button 105, 301 from the active smoking position into the non-active position, step 407. The release of the activation contact or button 105, 301 shifts the operation mode of the control circuitry 302 from the powered active mode into the powered non-active mode or sleep mode, step 408. At step 408, the control circuitry 302 controls the operation mode of the wireless communication or BlueTooth module 304 to be in the powered, non-active sleep mode, before the control circuitry 302 itself turns into the sleep mode.

At step 408, the user may decide that he wants a new smoking session, by pressing the activation contact or button 105, 301 into the active smoking position at time t6 and keeping the button 105, 301 in this position, step 404. The steps 405, 406, 407 and 408 are now repeated, with the user taking a puff between times t7 and t8, and releasing the activation contact or button 105, 301 from the active smoking position into the non-active position at time t9. At time t10 the user decides that no further smoking puffs will be taken, and from time t10 to time t11, the user presses the activation contact or button 105, 301 several times, such as three times, quickly in a row in order to power off the system 300, steps 409 and 410.

The operations performed from steps 404 and 405 at step 406 are further described in connection with FIGS. 5 and 6. The block diagram of FIG. 5 illustrates process operations between the control circuitry 302 and the heating system 305 with heating sensor 306, and between the control circuitry 302 and the wireless communication or BlueTooth module 304. At time t2, the user starts a smoking process by pressing the activation contact or button 105, 301 into an active smoking position and keeping the button 105, 301 in this position, step 404. When the button 105, 301 has been maintained in the smoking position for a minimum period, which is longer than one of the press periods used for powering the system in step 402, the operation mode of the control circuitry shifts from the powered non-active mode or sleep mode into an active mode, steps 405 and 501.

When in the active mode of step 501, the control circuitry 302 activates the heating system 305, step 502, by controlling battery power to be supplied to the heating system 305, while at the same time monitoring the temperature of the heating system 305 by reading the output from the temperature sensor 306. When the temperature of the heating system 305 reaches a predetermined maximum temperature, step 503, the control circuitry 302 de-activates the heating system 305, step 504, by de-activating the supply of battery power to the heating system 305. The heating system 305 is configured to obtain the maximum temperature within a time period, such as 2-3 seconds, which is less than the duration of a typical user puff, which may be 3-4 seconds.

When in the active mode of step 501, the wireless communication or BlueTooth module 304 is first in the sleep mode, but the control circuitry 302 now controls the operation mode of the wireless communication or BlueTooth module 304 to shift from the powered non-active mode or sleep mode into an active mode, 505, from where the wireless communication or Bluetooth module 304 goes into an active data communication mode, step 506. The wireless communication or Bluetooth module 304 is configured for being in the active data communication mode for a predetermined communication time, which may be no more than or less than 1 second, and lesser than the duration of a typical user puff, which may be 3-4 seconds. After lapse of the predetermined communication time period, the control circuitry 302 controls whether the wireless communication or BlueTooth module is still in a data communication session with an external computer or smartphone, steps 507 and 508, and if not, then the control circuitry 302 control the operation mode of the wireless communication or BlueTooth module 304 to shift from the active mode into the powered non-active mode or sleep mode, step 509. If yes, then the control circuitry 302 control the operation mode of the wireless communication or BlueTooth module 304 to shift from the active mode into the powered non-active mode or sleep mode when the data communication session is ended, step 509.

The block diagram of FIG. 5 further illustrates that when in the active mode of step 501, the control circuitry 302 may communicate with the battery charging control circuitry 308 to determine remaining battery charge, step 510, and the control circuitry 302 may then forward data representing the determined remaining battery charge to the wireless communication or BlueTooth module 304, see step 601 of FIG. 6. The wireless communication or BlueTooth module 304 may then forward the received data to the external computer or smartphone 200, step 505, when both the control circuitry 302 and the wireless communication or BlueTooth module 304 are in the active mode.

When the electronic smoking system 300 is part of an electronic cigarette 100, the system may also include an airflow sensor 309, which detects whenever a user puff is performed by detecting a change in air pressure caused by a user puff. As illustrated in FIG. 5, when the control circuitry 302 is in the active mode of step 501, it may activate the airflow sensor 309, and communicate with the airflow sensor 309 to determine if any user puffs are recorded, and the control circuitry 302 may then forward data representing detected user puffs to the wireless communication or BlueTooth module 304, see step 601 of FIG. 6. Again, the wireless communication or BlueTooth module 304 may then forward the received data to the external computer or smartphone 200, step 505, when both the control circuitry 302 and the wireless communication or BlueTooth module 304 are in the active mode. When the smoking session is ended by the user releasing the activation contact from the first, active smoking position into the second, non-active position, step 407 of FIG. 4 and step 602 of FIG. 6, the control circuitry 302 may de-activate the airflow sensor 309, step 603, before the control circuitry 302 shifts to the powered, non-active sleep mode, step 408 of FIG. 4 and step 604 of FIG. 6.

When the electronic smoking system 300 is part of an electronic cigarette 100, the system may also include one or more liquid volume sensors 310 for monitoring the remaining fluid or liquid in the liquid cartridge 103. When the control circuitry 302 is in the active mode of step 501, it may activate the liquid volume sensor(s) 310, and communicate with the volume sensor(s) 310 to determine the remaining liquid volume of the liquid cartridge 103. The control circuitry 302 may then forward data representing determined remaining liquid volume to the wireless communication or BlueTooth module 304, see step 601 of FIG. 6. Again, the wireless communication or BlueTooth module 304 may then forward the received data to the external computer or smartphone 200, step 505, when both the control circuitry 302 and the wireless communication or BlueTooth module 304 are in the active mode. When the smoking session is ended by the user releasing the activation contact from the first, active smoking position into the second, non-active position, step 407 of FIG. 4 and step 602 of FIG. 6, the control circuitry 302 may de-activate the liquid volume sensor(s) 310, step 603, before the control circuitry 302 shifts to the powered, non-active sleep mode, step 408 of FIG. 4 and step 604 of FIG. 6.

In order to power on or power off the system 300, the user presses the activation contact or button 105, 301 several times, such as three times, between t0 to t1 when powering on, or between t10 and t11 when powering off. In an embodiment the three times of activation shall be performed within a time limit of 2 seconds in order to change the operation mode of the control circuitry 302. From FIG. 7 it is seen that the time period from t0 to t1 holds 2.5 activation press periods, and when having the minimum puff time period, which is the minimum period for maintaining the button 105, 301 in the smoking position, set to be longer than one activation press period, this minimum puff time period should be at least 1 second, such as at least 1.5 second, or such as at least 2 seconds.

The duration of a typical user puff may be in the range of 3-4 seconds, and the predetermined communication time period, after which period the control circuitry 302 controls whether the wireless communication or BlueTooth module 304 is still in a data communication session with an external computer or smartphone, may be set to no more than 1 second, such as no more than 0.8 seconds, such as no more than 0.5 seconds.

The heating system may hold a heating coil for heating the liquid to be vaporized, and the temperature sensor may be a thermistor, such as a negative temperature coefficient, NTC, thermistor. The predetermined maximum temperature may be selected within the range of 150 to 350° C., such as set to 150° C., such as set to 250° C. or such as set to 350° C.

It is within an embodiment that the battery is a 5 V battery, which will supply a voltage about 5 V to the electronic circuits of the smoking system 300. However, the battery power supplied to the heating system may be controlled to be either 4.1 V, 3.6 V or 3 V, depending on the kind of liquid to be vaporized. The control circuitry 302 may be programmed to select the desired heating system voltage and a corresponding maximum heating temperature by several consecutive user activations of the activation contact or button 105, 301, following the number of user activations of the contact or button 105, 301 used for powering on the electronic smoking system 300 from the non-powered off mode to the powered sleep mode. In an embodiment a number of 4 consecutive user activations of the contact or button 105, 301 may program the control circuitry 302 to set the supply voltage to the heating system to about 3 V and the maximum temperature to about 150° C.; a number of 5 consecutive user activations of the contact or button 105, 301 may program the control circuitry 302 to set the supply voltage to the heating system to about 3.6 V and the maximum temperature to about 250° C.; and a number of 6 consecutive user activations of the contact or button 105, 301 may program the control circuitry 302 to set the supply voltage to the heating system to about 4.1 V and the maximum temperature to about 350° C. In order for the control circuitry to distinguish the voltage/temperature programming from the onset of a smoking session and from the powering off of the electronic smoking system 300, the 4 consecutive user activations of the contact or button 105, 301 should take no longer than 3 seconds, such as no longer than 2.5 seconds, such as no longer than 2 seconds; the 5 consecutive user activations of the contact or button 105, 301 should take no longer than 3.5 seconds, such as no longer than 3 seconds, such as no longer than 2.5 seconds; and the 6 consecutive user activations of the contact or button 105, 301 should take no longer than 4 seconds, such as no longer than 3.5 seconds, such as no longer than 3 seconds.

The liquid being consumed may hold a certain concentration of nicotine, which concentration may vary for different types of liquid. The concentration (which may be in mg/ml) will be known by the user, and the user can then enter the concentration into the application program 201 of the external computer or user device or smartphone 200. The data representing the remaining liquid volume and thereby the consumed liquid volume of liquid from the cartridge 103, which may be forwarded to user device 200, may then be used by the user device 200 to calculate the absolute amount of consumed nicotine. The consumed amount of nicotine can then be read by the user from the user device or smartphone 200. The user may also read the total number of puffs and/or the remaining battery charge from the user device or smartphone 200.

The user data to be forwarded to the user device or smartphone 200, may be stored by the control circuitry 302 of the electronic cigarette 100 for a minimum time period of one or several days, such as for example 2 to 5 days, which allows a user to receive the data if connecting the user device or smartphone 200 to the electronic cigarette 100 after one or more smoking sessions.

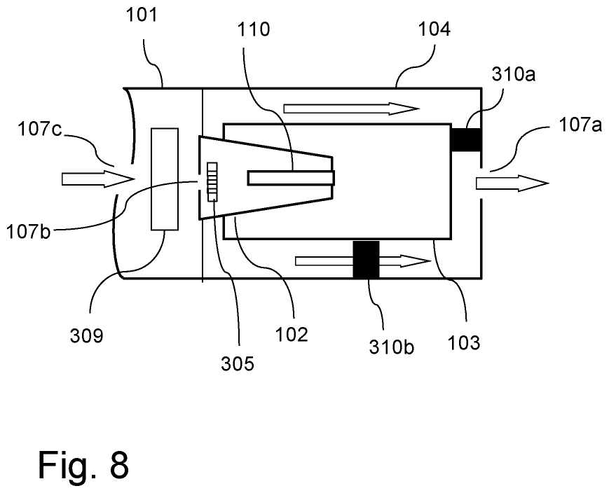

FIG. 8 is a block diagram, which in further detail illustrates the arrangement of the atomizing unit 102 within the electronic cigarette 100 according to an example embodiment. The first outer shell 101 is connected to the second outer shell 104, where the atomizing unit 102 is housed in the second outer shell 104 while being connected to the electronic section, which is housed by the first outer shell 101. The liquid cartridge 103 is connected to the atomizing unit 102, which in one end holds a wick 110, which may suck the liquid from the cartridge 103, and in the other end holds the heating system 305, which in this case is a heating coil. The temperature sensor 306 of the heating system is not shown in FIG. 8. Electric connections (not shown) are provided between the heating system 305 and the electronic control circuitry 302 and 303 within the first outer shell 101. The second outer shell 104 has an air outlet orifice 107a at the mouth end, and the atomizing unit 102 has an air inlet orifice 107b for inlet of air.

An airflow sensor 309 is arranged in the first outer shell 101 and may face the air inlet orifice 107b of the atomizing unit 102. One or more air passages 107c are provided within the first outer shell 101 between the airflow sensor 309 and the air inlet orifice 106 (not shown in FIG. 8) of the first outer shell 101. When the heating is turned on and a user takes a puff at the orifice 107a, air is directed through the air passage 107c, through the inlet orifice 107b and into the atomizing unit 102, where the air is heated and removes liquid droplets from the wick 110, thereby atomizing the liquid into a vaporized mixture of air and vaporized liquid or fluid. The vaporized mixture of air and liquid or fluid is the passed through a number of small air passages (not shown) in the atomizing unit 102, along the sides of the cartridge 103, through the air outlet orifice 107a, and into the mouth of the user. The flow or air, when a user takes a puff, is illustrated by the arrows in FIG. 8

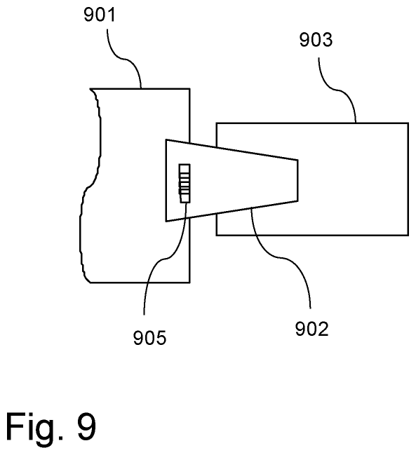

Two volume sensors 310a and 310b may be arranged within the second outer shell 104. The volume sensors may be a first force sensor 310a and a second force sensor 310b, where the first force sensor 310a contacts an outer bottom part of the liquid cartridge 103 and the second force sensor 310b contacts an outer side part of the liquid cartridge 103. Electric contacts (not shown) may be provided between the first and second outer shells 101, 104 in order for the control circuitry 302, 303 to be in electronic communication with the force sensors 310a, 310b.
a. FIG. 9 is a block diagram illustrating heating of a tobacco plug 903 according to an example embodiment. An electronic smoking system similar to the system 300 of FIG. 3, but without the airflow sensor 309 and the volume sensor 310, may be arranged within a housing 901. A heat transfer element 902 is arranged at one end of the housing and holding a heating system 905, which may be equivalent to the heating system 305 of FIG. 3, which heating system 905 may also hold a temperature sensor (not shown). The heat transfer element 902 is configured for being attached to a tobacco plug, which may be of the kind used for “Heat-not-burn” cigarettes. The predetermined maximum temperature may be selected within the range of 150 to 350° C., such as set to 150° C., such as set to 250° C. or such as set to 350° C.

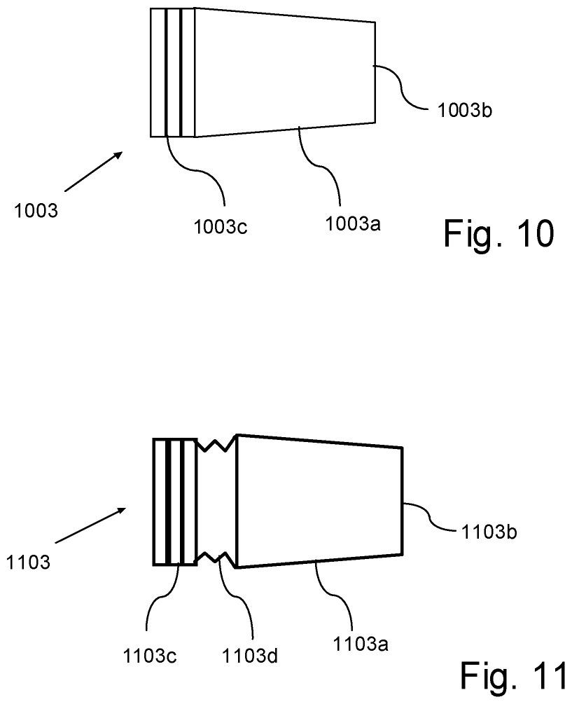

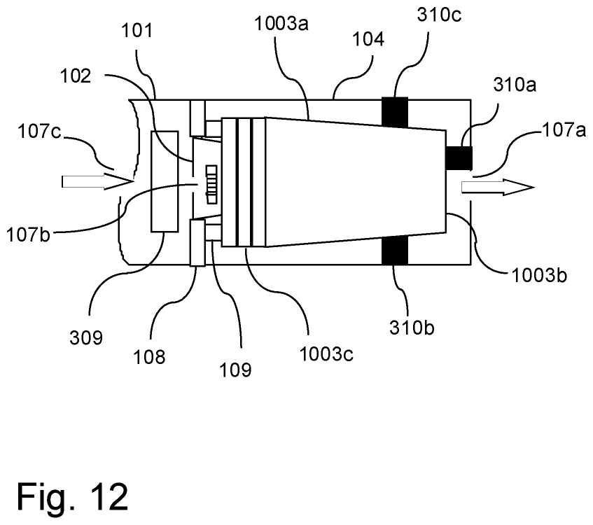

FIG. 10 shows a liquid cartridge 1003 for use in an electronic cigarette according to an example embodiment. The liquid cartridge 1003 is formed by a cylindrical side wall 1003a, a bottom wall 1003b, and a top part 1003c. The side wall 1003a and the bottom wall 1003b may both be made of a flexible material, such as a flexible plastic material, while the top part 1003c may be made of a substantially rigid material, such as a rigid plastic material. The top part 1003c may hold a threaded part for attachment of the liquid cartridge to the outer shell 101, 104, of an electronic cigarette. The threaded part may be inwards threaded in order to fit an outwards threaded part of the outer shell 101, 104. By having the walls 1003a and 1003b made of a flexible material, the walls 1003a and 1003b may be deformed more or less as a function of the fluid volume within the cartridge 1003, which may cause a changing gravity force exerted by the cartridge 1003 when being in touch with force or pressure sensors 310a, 310b, 310c, see FIG. 12.

FIG. 11 shows another liquid cartridge 1103 for use in an electronic cigarette according to an example embodiment. The liquid cartridge 1103 is formed by a cylindrical side wall 1103a, a bottom wall 1103b, a top part 1103c, and a flexible interconnecting part 1103d.

The interconnecting part 1103d provides a flexible interconnection between the top part 1103c and the side wall 1103a. The side wall 1103a and the bottom wall 1103b may both be made of a flexible or rigid material, such as a flexible or rigid plastic material, while the top part 1103c may be made of a substantially rigid material, such as a rigid plastic material. It is within a preferred embodiment that the side wall 1103a and the bottom wall 1103b are both made of a rigid material, such as a rigid plastic material. Also here, the top part 1103c may hold a threaded part for attachment of the liquid cartridge to the outer shell 101, 104, of an electronic cigarette. The threaded part may be inwards threaded in order to fit an outwards threaded part of the outer shell 101, 104. The use of the flexible interconnection part 1103d allows the side and bottom walls 1103a and 1103b to change position relative to the top part 1103c, where the change in position may vary as a function of the fluid volume within the cartridge 1103, which may cause a changing gravity force exerted by the cartridge 1103 when being in touch with force or pressure sensors 310a, 310b, 310c, see FIG. 12.

FIG. 12 is a block diagram illustrating the arrangement of an atomizer or atomizing unit 102 and the liquid cartridge 1003 within the electronic cigarette 100 according to an example embodiment. The electronic cigarette 100 and the atomizer 102 is similar to the components described in connection with FIG. 8. The electronic cigarette 100 has the first outer shell 101 connected to the second outer shell 104, where the atomizing unit 102 is housed in the second outer shell 104 while being fixedly connected to the first outer shell 101 by fastenings elements 108, which may be inwards threaded with the atomizing unit having an outwards threaded part for connecting to the elements 108. The atomizing unit is also electronically connected to the electronic section, which is housed by the first outer shell 101. The top part 1003c of the liquid cartridge 1003 is fixedly connected to the first outer shell 101 by fastenings elements 109, which may be outwards threaded with the top part 1003c being inwards threaded for connecting to the elements 109. The elements 108 and 109 are positioned and configured to hold the liquid cartridge 1003 in a desired position relative to the atomizing unit 102. It is noted that the cartridge 1003 is detachably secured to the first outer shell 101, allowing an easy refill of the liquid cartridge 1003, when the fluid volume gets too low. When the cartridge 1003 has been connected to the first outer shell 101, the first outer shell 101 is connected to the second outer shell 104, which may be by use of a push fitting or snap fitting.

A number of force or pressure sensors 310a, 310b, 310c are arranged within the second outer shell 104 and positioned in order to contact outer wall surfaces of the liquid cartridge 1003, when the liquid cartridge 1003 is brought into position inside the second outer shell 1004 by the first outer shell 101 being connected to the second outer shell 104. By having the walls 1003a and 1003b made of a flexible material, the walls 1003a and 1003b may be deformed as a function of the fluid volume within the cartridge 1003, which may cause a changing gravity force exerted by the cartridge 1003 when being in touch with the force or pressure sensors 310a, 310b, 310c. FIG. 12 shows the arrangement of the liquid cartridge 1003 of FIG. 10 into the electronic cigarette 100. However, the present disclosure also covers embodiments in which the liquid cartridge 1103 of FIG. 11 is taking place of the cartridge 1003 in the arrangement illustrated in FIG. 12. For the cartridge 1103, the use of the flexible interconnection part 1103d allows the side and bottom walls 1103a and 1103b to change position relative to the top part 1103c, where the change in position may vary as a function of the fluid volume within the cartridge 1103, which may cause a changing gravity force exerted by the cartridge 1103 on the force or pressure sensors 310a, 310b, 310c.

In the configuration show in FIG. 12, there are three force or pressure sensors 310a, 310b, 310c, which are arranged within the inner side wall surface of the second outer shell 104, where sensors 310b and 310c are contacted by the outer wall surface of the side wall 1003a, and sensor 310a are contacted by the bottom wall 1003b. It is also within embodiments of the present disclosure that only one force or pressure sensor is used, which could be a single sensor 310a arranged to contact the bottom wall 1003b, or a single sensor 310b or 310c arranged to contact the side wall 1003a. It is also within embodiments of the present disclosure that two force or pressure sensors are used, which could be a single sensor 310a arranged to contact the bottom wall 1003b, and a single sensor 310b or 310c arranged to contact the side wall 1003a, or it could be two sensors 310b and 310c arranged to contact the side wall 1003a with no sensor 310a in contact with the bottom wall.

Electric contacts (not shown) are provided between the first and second outer shells 101, 104 in order for control circuitry 302, 303 (see FIG. 3) within the first outer shell to be in electronic communication with the force or pressure sensors 310a, 310b, 310c. The force or pressure detecting sensors 310a, 310b, 310c may be piezoresistive strain gauge type sensors, such as compression load cells, which may be micro-machined piezoresistive strain gauge cell. It is also within embodiments that the force or pressure detecting sensors 310a, 310b, 310c are force sensing resistor type sensors.

The second outer shell 104 has an air outlet orifice 107a at the mouth end, and the atomizing unit 102 has an air inlet orifice 107b for inlet of air. An airflow sensor 309 may be arranged in the first outer shell 101 and may face the air inlet orifice 107b of the atomizing unit 102. One or more air passages 107c are provided within the first outer shell 101 between the airflow sensor 309 and the air inlet orifice 106 (not shown in FIG. 8) of the first outer shell 101. When the heating is turned on and a user takes a puff at the orifice 107a, air is directed through the air passage 107c, through the inlet orifice 107b and into the atomizing unit 102, where the air is heated and removes liquid droplets from the wick 110 (see FIG. 8), thereby atomizing the liquid into a vaporized mixture of air and vaporized liquid or fluid. The vaporized mixture of air and liquid or fluid is the passed through a number of small air passages (not shown) in the atomizing unit 102, and through air passages (not shown) in the fastening elements 109, and along the sides of the cartridge 1003, through the air outlet orifice 107a, and into the mouth of the user.

In order for a user to be informed of the remaining liquid within the liquid cartridge 1003, 1103, the control circuitry 302, 303 may be configured for determining the remaining volume of the fluid within the liquid cartridge based at least partly on received force/pressure data detected by the force/pressure detecting sensors 310a, 301b, 310c. When two or more sensors 310a, 310b, 310c are used, the control circuitry may be configured for combining or summing the detected and received force/pressure data, and for determining the remaining volume of the fluid within the liquid cartridge 1003, 1103 based at least partly on the resulting combined or summed force/pressure data.

It should be understood that the gravity force of pressure detected by the sensors 310a, 310b, 310c varies as a function of the vertical/horizontal position of the liquid cartridge 1003, 1103 and thereby with the position of the electronic cigarette 100. When the electronic cigarette 100 and cartridge 1003, 1103 are held in a vertical position, there is a maximum pressure on the sensor 310a being in contact with the bottom wall 1003b, 1103b, while when the electronic cigarette 100 and cartridge 1003, 1103 are held in a horizontal position, there is a maximum pressure on the sensor 310b being in contact with the side wall 1003a, 1103a. Thus, the control circuitry 302, 303 may be configured for determining a maximum value of the received force/pressure data or for determining a maximum value for the combined or summed force/pressure data, and further configured for determining the remaining volume of the fluid within the liquid cartridge based at least partly on said determined maximum value.

In order for the control circuitry 302, 303 to determine the remaining volume of the fluid based on the detected force/pressure data, it may be necessary to have a measure for the minimum and maximum gravity force or pressure values, wherein the minimum value represents the force or pressure exerted by a liquid cartridge 1003, 1103 holding a minimum fluid volume or being empty, and the maximum value represents the force or pressure exerted by a liquid cartridge 1003, 1103 holding a maximum fluid volume. Thus the control circuitry 302, 303 may hold stored information representing such minimum and maximum gravity force or pressure values, and the control circuitry 302, 303 may be configured for determining a remaining volume of the fluid within the liquid cartridge 1003, 1103 based on received force/pressure data detected by the one or more force/pressure detecting sensors 301, 301b, 301c and the stored minimum and maximum force/pressure values. Here, the control circuitry 302, 303 may be configured for determining the remaining volume of the fluid within the liquid cartridge 1003, 1103 based at least partly on the combined or summed force/pressure data and the stored minimum and maximum force/pressure values. The control circuitry 302, 303 may also or alternatively be configured for determining the remaining volume of the fluid within the liquid cartridge 1003, 1103 based on the determined maximum value and the stored minimum and maximum force/pressure values.

It is within embodiments of the disclosure that the electronic cigarette 100 comprises a short range wireless communication module 304 (see FIG. 3) in electronically communication with the control circuitry 302, 303 and configured for wireless data communication of a determined remaining fluid volume to an external computer or smartphone 200 (see FIG. 3).

The airflow sensor 309 may be configured for detecting a change in air pressure caused by a user puff, and the control circuitry 302, 303 and the airflow sensor 309 may be configured for detecting a lowering in air pressure, which may be caused by a user taking no more puffs. Here, the control circuitry 302, 303 may be configured for determining the remaining volume of the fluid within the liquid cartridge 1003, 1103 following a detection of a lowering in air pressure.

The present disclosure has been described in conjunction with various embodiments herein. However, other variations to the disclosed embodiments can be understood and effected by those skilled in the art in practicing the claimed present disclosure, from a study of the drawings, the disclosure, and the appended claims. In the claims, the word “comprising” does not exclude other elements or steps, and the indefinite article “a” or “an” does not exclude a plurality.

1-28. (canceled)

29. An electronic smoking system comprising an electronic cigarette having an outer shell with an orifice, said outer shell comprising:
a liquid cartridge holding a fluid to be vaporized into a vaporized mixture of air and vaporized fluid;
an atomizer for vaporizing the fluid; and
a sensor system with one or more sensors configured for detecting a force or pressure exerted by an outer wall surface of the liquid cartridge on the sensor(s), said detected force or pressure relating to the fluid volume of the liquid cartridge; wherein
the liquid cartridge comprises one or more flexible parts providing a flexibility to the liquid cartridge relative to the outer shell, thereby allowing the liquid cartridge to exert a gravity force on said sensor(s), said gravity force being at least partly a function of the fluid volume of the liquid cartridge; or characterized in that the outer shell has one or more inner side wall surfaces and an inner bottom wall surface, which inner surfaces at least partly enclose the liquid cartridge, said liquid cartridge being formed by a least one or more side wall parts, a bottom wall part and a top part, with at least one sensor being positioned between the inner bottom wall surface of the outer shell and the outer bottom wall surface of the liquid cartridge.

30. An electronic smoking system according to claim 29,
wherein at least one sensor is positioned between an inner side wall surface of the outer shell and an outer side wall surface of the liquid cartridge.

31. An electronic smoking system according to claim 29, wherein the sensor system holds at least two sensors arranged for detecting a force or pressure exerted by one or more outer wall surfaces of the liquid cartridge on said sensors.

32. An electronic smoking system according to claim 29, wherein
the liquid cartridge comprises one or more flexible wall parts; and
the sensor(s) is/are positioned for detecting a gravity force or pressure exerted from an outer surface of said one or more flexible wall parts.

33. An electronic smoking system according to claim 29, wherein the bottom wall part of the liquid cartridge holds a flexible wall part facing said at least one sensor positioned between the inner bottom wall surface of the outer shell and the outer bottom wall surface of the liquid cartridge, and/or
wherein at least one side wall part of the liquid cartridge holds a flexible wall part facing said at least one sensor positioned between an inner side wall surface of the outer shell and an outer side wall surface of the liquid cartridge.

34. An electronic smoking system according to claim 29, wherein
the liquid cartridge has one or more side wall parts, a bottom wall part, a top part attached to the outer shell, and a flexible interconnection part providing a flexible connection between the top part and the side wall parts; and wherein the sensor(s) is/are positioned for detecting a gravity force or pressure exerted from an outer surface of said one or more side and/or bottom wall parts.

35. An electronic smoking system according to claim 29, wherein said one or more force or pressure detecting sensors include one or more piezoresistive strain gauge type sensors and/or one or more force sensing resistor type sensors.

36. An electronic smoking system according to claim 29, wherein the liquid cartridge is formed by a least one or more side wall parts, a bottom wall part and a top part, and wherein the side wall parts and the bottom wall part are at least partly made of a plastic material or flexible plastic material.

37. An electronic smoking system according to claim 36, wherein the top part comprises a threaded part for attachment of the liquid cartridge to the outer shell.

38. An electronic smoking system according to claim 34, wherein the flexible interconnection part is made of a flexible plastic material.

39. An electronic smoking system according to claim 29, wherein the electronic cigarette further comprises:
control circuitry in electronically communication with the sensor system, said control circuitry being configured for determining the remaining volume of the fluid within the liquid cartridge based at least partly on received force/pressure data detected by the one or more force/pressure detecting sensors.

40. An electronic smoking system according to claim 39, wherein the control circuitry is configured for determining the remaining volume of the fluid within the liquid cartridge based at least partly on received force/pressure data detected by at least two force/pressure detecting sensors.

41. An electronic smoking system according to claim 40, wherein the control circuitry is configured for combining or summing the received force/pressure data detected by the at least two force/pressure detecting sensors, and for determining the remaining volume of the fluid within the liquid cartridge based at least partly on the resulting combined or summed force/pressure data.

42. An electronic smoking system according to claim 39, wherein the control circuitry is configured for determining a maximum value of the received force/pressure data or for determining a maximum value for the combined or summed force/pressure data, and further configured for determining the remaining volume of the fluid within the liquid cartridge based at least partly on said determined maximum value.

43. An electronic smoking system according to claim 39, wherein the control circuitry holds stored information representing minimum and maximum gravity force or pressure values, wherein the minimum value represents the force or pressure exerted by a liquid cartridge holding a minimum fluid volume and the maximum value represents the force or pressure exerted by a liquid cartridge holding a maximum fluid volume, and wherein the control circuitry is configured for determining a remaining volume of the fluid within the liquid cartridge based on received force/pressure data detected by the one or more force/pressure detecting sensors and the stored minimum and maximum force/pressure values.

44. An electronic smoking system according to claim 41, wherein the control circuitry is configured for determining the remaining volume of the fluid within the liquid cartridge based at least partly on the combined or summed force/pressure data and the stored minimum and maximum force/pressure values.

45. An electronic smoking system according to claim 42, wherein the control circuitry is configured for determining the remaining volume of the fluid within the liquid cartridge based on said determined maximum value and the stored minimum and maximum force/pressure values.

46. An electronic smoking system according to claim 41, wherein the electronic cigarette further comprises: a short range wireless communication module in electronically communication with the control circuitry and configured for wireless data communication of a determined remaining fluid volume to an external computer or smartphone.

47. An electronic smoking system according to claim 29, wherein the electronic cigarette further comprises:
a heating system for heating the fluid to be vaporized and including a temperature sensor for sensing the temperature of the heating system, wherein the heating system is part of the atomizer and the atomizer is arranged for vaporizing the fluid into said mixture when a user puffs on the orifice and heat is delivered from the heating system; and
a power delivering battery.

48. An electronic smoking system according to claim 29, wherein the electronic cigarette further comprises:
an airflow sensor for detecting a change in air pressure caused by a user puff;
wherein the control circuitry and the airflow sensor are configured for detecting a lowering in air pressure; and wherein the control circuitry is configured for determining the remaining volume of the fluid within the liquid cartridge following a detection of a lowering in air pressure.

49. A liquid cartridge for holding a consumption fluid for an electronic cigarette, said liquid cartridge comprising one or more side wall parts, a bottom wall part, a rigid top part, and a flexible interconnection part providing a flexible connection between the top part and the side wall parts.

50. A liquid cartridge according to claim 49, wherein the top part comprises a threaded part for attachment of the liquid cartridge to an outer shell of an electronic cigarette.

51. A liquid cartridge according to claim 49, wherein the flexible interconnection part is made of a flexible plastic material.

52. A liquid cartridge according to claim 49, wherein the one or more side wall parts and the bottom wall part are at least partly made of a non-flexible or rigid plastic material.

53. A method of controlling power consumption during a smoking session performed by use of an electronic smoking system comprising an activation contact, a heating system for heating a fluid to be vaporized or for heating a tobacco plug and including a temperature sensor for sensing the temperature of the heating system, a short range wireless communication module configured for wireless data communication with an external computer or smartphone, control circuitry in electronically communication with the activation contact and the heating system and the short range wireless communication module, and a battery for powering the heating system and the short range wireless communication module and the control circuitry, said method comprising:
shifting the operation mode of the control circuitry from a powered non-active mode or sleep mode into an active mode by having a user maintaining the activation contact in a first, active smoking position for at least a predetermined minimum puff time period to thereby start a smoking session;
supplying battery power to the heating system when the operation mode of the control circuitry is shifted into said active mode;
determining the temperature of the activated heating system;
de-activating the battery power supply to the heating system when the heating system temperature reaches a predetermined maximum temperature or when the activation contact is turned from the first, active smoking position into a second, non-active position;
shifting the operation mode of the short range wireless communication module from a powered non-active mode or sleep mode into an active data communication mode when the control circuitry is turned into said active mode;
determining after lapse of a predetermined communication time period starting from turning the short range wireless communication module into said active data communication mode, whether the short range wireless communication module is in a data communication session with an external computer or smartphone; if not, then
shifting the operation mode of the short range wireless communication module into the powered non-active mode or sleep mode; and if yes, then
shifting the operation mode of the short range wireless communication module into the powered non-active mode or sleep mode when the data communication session is ended.

54. An electronic smoking system comprising:
an activation contact;
a heating system for heating a fluid to be vaporized or for heating a tobacco plug and including a temperature sensor for sensing the temperature of the heating system;
a short range wireless communication module configured for wireless data communication with an external computer or smartphone;
control circuitry in electronically communication with the activation contact, the heating system and the short range wireless communication module; and
a battery for powering the heating system, the short range wireless communication module, and the control circuitry;
wherein the control circuitry is configured for:
shifting operation mode from a powered non-active mode or sleep mode into an active mode when the activation contact is maintained in a first, active smoking position for at least a predetermined minimum puff time period;
activating the heating system by directing battery power supply to the heating system when the activation contact is maintained in said first, active smoking position;
determining the temperature of the activated heating system;
de-activating the battery power supply to the heating system when the heating system temperature reaches a predetermined maximum temperature or when the activation contact is turned from the first, active smoking position into a second, non-active position;
shifting the operation mode of the short range wireless communication module from a powered non-active mode or sleep mode into an active data communication mode when the activation contact is maintained in the first, smoking active position;
determining after lapse of a predetermined communication time period starting from the shifting of operation mode of the short range wireless communication module into said active data communication mode, whether the short range wireless communication module is in a data communication session with an external computer or smartphone; if not, then
shifting the operation mode of the short range wireless communication module into the powered non-active mode or sleep mode; and if yes, then
shifting the operation mode of the short range wireless communication module into the powered non-active mode or sleep mode when the data communication session is ended.
